(19) United States
(12) Patent Application Publication
(10) Pub. No.: US 2017/0292041 A1
(43) Pub. Date: Oct. 12, 2017

(54) PRESSURE-SENSITIVE ADHESIVE

(71) Applicant: tesa SE, Norderstedt (DE)

(72) Inventors: MARTA LUNDING, HAMBURG (DE); JULIA BEFUSS, NORDERSTEDT (DE); ALEXANDER PRENZEL, HAMBURG (DE); THOMAS SCHUBERT, HAMBURG (DE)

(73) Assignee: tesa SE, Norderstedt (DE)

(21) Appl. No.: 15/480,459

(22) Filed: Apr. 6, 2017

(30) Foreign Application Priority Data
Apr. 7, 2016 (DE) 10 2016 205 822.3

(51) Int. Cl. C09J 7/02; C09J 11/08

(52) U.S. Cl. CPC C09J 7/0246; C09J 11/08; C09J 7/0289; C09J 2201/606; C09J 133/12

(57) ABSTRACT

A pressure-sensitive adhesive for bonding to various surfaces, such as metals, plastics, and also vehicle finishes, with rapid wetting and high adhesion, with good shear strengths and bond strengths under different conditions and without undergoing dewetting even under lasting mechanical load, comprises:
a) at least 50 wt % of at least one polymer A whose monomer basis comprises the following monomers:
   a1) at least one (meth)acrylic ester having a homopolymer glass transition temperature of not more than −60° C. and an alcohol component based on a branched, primary alcohol, having an iso index of 1;
   a2) at least one (meth)acrylic ester having an alcohol component based on a linear C₁-C₁₈ alcohol;
   a3) acrylic acid;
b) at least 5 wt % of at least one synthetic rubber; and
c) at least 10 wt % of at least one peel adhesion-reinforcing resin.

Also disclosed is an adhesive tape comprising a foamed carrier and the pressure-sensitive adhesive.

This application claims priority of German Patent Application No. 10 2016 205 822.3, filed on Apr. 7, 2016, the entire contents of which are incorporated herein by reference.

The invention pertains to the technical field of pressure-sensitive adhesives as used in single-sided and double-sided adhesive tapes. More specifically the invention relates to a pressure-sensitive adhesive based on a combination of at least one poly(meth)acrylate, deriving from a particular monomer composition, with at least one synthetic rubber.

One of the targets of the invention is the parameter of “wetting”, which is relevant from the technical adhesive standpoint. Wetting is understood below to refer to the development of an interface between a pressure-sensitive adhesive and the substrate to be bonded. The term “wetting” therefore describes the capacity of a pressure-sensitive adhesive to level out unevennesses and to displace air between itself and the substrate. The greater the wetting, the more effectively the interactions between pressure-sensitive adhesive and substrate are able to develop and the better, therefore, the sticking and the adhesion. A frequent observation, particularly on rough surfaces or surfaces with production-related unevennesses or curvatures or corrugations, is that wetting once achieved becomes weaker again as a result of mechanical loads—in other words, that dewetting occurs.

Wetting should be distinguished from the development of peel adhesion over time. Even when initial wetting is good, the peel adhesion may still rise over time, since increasing numbers of functional groups present in the adhesive and able to interact with the surface become oriented towards that surface.

For diverse fields of application, such as in the construction sector, in the industrial manufacture of technical products, or for assembly purposes, there is a requirement for adhesive tapes which are increasingly thick but also strongly bonding (referred to as “adhesive assembly tapes”). Since the bonds frequently take place outdoors and/or the bonded products are subject to external weathering effects, the expectations of the properties of such adhesive tapes are frequency high. Hence the bond is to be strong, durable and weather-resistant; in many cases, high moisture resistance, heat resistance and resistance to combined heat and humidity are required. The adhesives, moreover, are to rapidly wet and, in so doing, level out unevennesses in the bondline and/or on the substrates to be bonded, and to exhibit high peel adhesion from the start (initial peel adhesion). When using unfoamed adhesive tapes, a further advantage of effective wetting is that it enables transparent materials to be bonded without optical defects, as is increasingly being desired even for thick adhesive tapes (in the bonding, for instance, of transparent materials such as glasses or transparent plastics).

The adhesive tapes employed for such purposes are commonly equipped with adhesives for which the technical adhesive properties must be matched very well to one another. For instance, cohesion, initial tack, flow behaviour and other properties must be very finely tuned. Given that the technical forms of the pressure-sensitive adhesive, which influence these properties, frequently have divergent effects on the individual properties, fine tuning is generally difficult, or a compromise must be accepted in the outcome.

For very thick adhesive tapes in particular it is frequently difficult, moreover, to realize highly homogeneous adhesive tapes; as a result of processing, very thick adhesive tapes are frequently not homogeneous right through the layer. This is usually undesirable, given the frequent requirement for adhesive tapes which have well-defined properties irrespective of their layer thickness and of their production.

Substances having viscoelastic properties suitable for pressure-sensitive adhesive applications are notable in reacting to mechanical deformation both with viscous flow and with elastic resilience forces. In terms of their respective proportion, the two processes are in a certain relationship to one another, dependent not only on the precise composition, structure and degree of crosslinking of the substance in question but also on the rate and the duration of the deformation, and on the temperature.

The proportional viscous flow is necessary for achievement of adhesion. Only the viscous components, produced by macromolecules having relatively high mobility, permit effective wetting and effective flow onto the substrate to be bonded. A high proportion of viscous flow results in high intrinsic adhesiveness (also referred to as pressure-sensitive adhesiveness or as tack) and hence often also to a high peel adhesion. Highly crosslinked systems, crystalline polymers or polymers exhibiting glass-like solidification generally lack intrinsic adhesiveness, in the absence of flowable components.

The proportional elastic resilience forces are necessary for the achievement of cohesion. They are produced, for example, by very long-chain and highly entangled macromolecules, and also by physically or chemically crosslinked macromolecules, and they allow the transmission of the forces which act on an adhesive bond. They are responsible for endowing an adhesive bond with the capacity to withstand a sustained load acting on it, in the form of a long-term shearing load, for example, to a sufficient extent and over a relatively long period of time.

In foamed multi-layer adhesive tapes, a sustained load may result in uneven distribution of stress, which, if the forces are greater than the adhesion of the layer of pressure-sensitive adhesive to the surface, are manifested in partial detachment of the layer of pressure-sensitive adhesive. The proportion of the area that is wetted therefore becomes smaller.

In order to prevent the pressure-sensitive adhesives flowing off (running down) from the substrate, and to guarantee sufficient stability of the pressure-sensitive adhesive in the bonded assembly, sufficient cohesion of the pressure-sensitive adhesives is therefore necessary. For good adhesion properties, however, the pressure-sensitive adhesives must additionally be capable of flowing onto the substrate, developing interactions with the surface in the boundary layer sufficiently, and guaranteeing effective and durable wetting of the substrate surface. In order to prevent fractures within the bondline (within the layer of pressure-sensitive adhesive), moreover, a certain elasticity on the part of the pressure-sensitive adhesive is required.

To achieve sufficient cohesion on the part of the pressure-sensitive adhesives, they are generally crosslinked—that is, individual macromolecules are linked to one another by bridging bonds. Crosslinking may be accomplished in a variety of ways: there are physical and chemical (thermal) crosslinking methods, for example.

In order to produce homogeneous adhesive tapes it is an advantage to subject polymers to thermal crosslinking: it is readily possible even for thick layers to be supplied uniformly with thermal energy. Layers of adhesive crosslinked by actinic radiation (ultraviolet radiation or electron beams, for example), in contrast, exhibit a profile of crosslinking through the crosslinked layer. This crosslinking profile results from the fact that the radiation is limited in its depth of penetration into the layer, with the intensity of the radiation also decreasing in line with the depth of penetration, owing to absorption processes. Consequently, the outer regions of a radiation-crosslinked adhesive layer are crosslinked to a greater extent than the regions located more internally, with the intensity of crosslinking decreasing towards the interior overall. For thick layers in particular, this effect is very significant.

EP 2 305 389 A2 and EP 2 617 789 A1, for instance, describe thermally crosslinked, foamed and unfoamed adhesive assembly tapes having good adhesive and cohesive properties. These adhesive tapes, however, exhibit comparatively poor wetting behaviour and also, additionally, exhibit weaknesses in bonding to apolar substrates, especially to car finishes.

WO 2014/081 623 A2 describes UV-crosslinked, multi-layer adhesive assembly tapes having very good bond strengths to car finishes. This is achieved through the use of 2-propylheptyl acrylate (PHA) as a comonomer in the outer layer of pressure-sensitive adhesive, with preferred comonomer compositions described comprising mixtures of PHA and another comonomer with an ethylenically unsaturated group. The latter comonomers are, in particular, (meth)acrylates having branched, cyclic or aromatic alcohol components, such as with isobornyl acrylate (IBOA), for example, an acrylic ester with a high homopolymer glass transition temperature and a bicyclic radical.

US 2011/0244230 A1 describes an acrylate-based foam adhesive tape which is particularly conforming and is highly suitable for bonding on uneven substrates. However, the adhesive tapes described are crosslinked by UV radiation, and so the resulting crosslinking gradient results in relatively poor wetting behaviour.

EP 2 690 147 A2 describes styrene block copolymer-based, pressure-sensitive adhesives which, in combination with thermally crosslinked, syntactic polyacrylate foams, display outstanding properties in respect of bonding to apolar substrates in particular. The pressure-sensitive adhesives described have a high elasticity. They are therefore poorly suited to bonding to surfaces which have production-related unevennesses, are corrugated, or have a curvature. The expectation is that with these adhesives, wetting will decrease over time as a result of mechanical loads—in other words, that dewetting will occur.

EP 2 474 587 A1 describes pressure-sensitive adhesive tapes comprising a foamed polyacrylate carrier and also at least one outer layer of pressure-sensitive adhesive which is a blend of a styrene block copolymer and a polyacrylate. Added tackifier resins are described, being soluble in particular in the styrene block copolymer domains. According to the examples, advantage is possessed by polyacrylates which are prepared by UV polymerization and which consist in particular of acrylic acid, butyl acrylate, ethyl acrylate, isooctyl acrylate and 2-ethylhexyl acrylate. These blend formulations suggest that in view of the rigidity of the layer of pressure-sensitive adhesive, instantaneous wetting is relatively slight.

It is an object of the invention to specify powerful pressure-sensitive adhesives, especially for strongly bonding double-sided pressure-sensitive adhesive tapes. The pressure-sensitive adhesives are to provide rapid wetting of surfaces having different surface energies, examples being metals, surfaces of plastics such as PP, PE, polycarbonate, and also motor vehicle finishes, while developing a high level of adhesion. Moreover, the pressure-sensitive adhesives and the bonds produced using them are to exhibit high shear strength even at elevated temperatures, high resistance to combined heat and humidity, and high bond strength under dynamic load, the latter in particular at low temperatures. Finally, a long-lasting mechanical load on the bond is not to result in dewetting of the adhesive tape from the surface.

The achievement of the object is based on the idea of using, as a principal component of the pressure-sensitive adhesive, a poly(meth)acrylate which is based substantially on a mixture of monomers having singly branched and unbranched alcohol components, and combining this polymer with a synthetic rubber.

A first and general subject of the invention is a pressure-sensitive adhesive which comprises

a) at least 50 wt %, based on the total weight of the pressure-sensitive adhesive, of at least one polymer A whose monomer basis comprises the following monomers:
a1) at least one (meth)acrylic ester having a homopolymer glass transition temperature of not more than −60° C. and an alcohol component based on a branched, primary alcohol, having an iso index of 1;
a2) at least one (meth)acrylic ester having an alcohol component based on a linear C₁-C₁₈ alcohol;
a3) acrylic acid;

b) at least 5 wt %, based on the total weight of the pressure-sensitive adhesive, of at least one synthetic rubber; and

c) at least 10 wt %, based on the total weight of the pressure-sensitive adhesive, of at least one peel adhesion-reinforcing resin.

A pressure-sensitive adhesive of the invention is notable in particular for rapid wetting of low-energy surfaces and for high dewetting resistance even under lasting mechanical load on the bond, and also for good other technical adhesive properties.

### BRIEF DESCRIPTION OF THE DRAWINGS

The invention will now be described in greater detail with reference to the drawings, wherein:

FIG. 1 shows a device for performing at step wetting test;

FIG. 2a shows the device of FIG. 1 from above;

FIG. 2b shows the device of FIG. 1 from below; and

FIG. 3 shows an experimental unit for foaming the carrier.

A pressure-sensitive adhesive (PSA) is understood in accordance with the invention, as customary generally, as a material which in particular at room temperature is permanently tacky and also adhesive. Characteristics of a pressure-sensitive adhesive are that it can be applied by pressure to a substrate and remains adhering there, with no further definition of the pressure to be applied or the period of exposure to this pressure. In some cases, depending on the precise nature of the pressure-sensitive adhesive, the temperature, the atmospheric humidity, and the substrate, exposure to a minimal pressure of short duration, which does not go beyond gentle contact for a brief moment, is enough to achieve the adhesion effect, while in other cases a longer-term period of exposure to a high pressure may also be necessary.

Pressure-sensitive adhesives have particular, characteristic viscoelastic properties which result in the permanent tack and adhesiveness. A characteristic of these adhesives is that when they are mechanically deformed, there are processes of viscous flow and there is also development of elastic resilience forces. The two processes have a certain relationship to one another in terms of their respective proportion, in dependence not only on the precise composition, the structure and the degree of crosslinking of the pressure-sensitive adhesive but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also to a high peel adhesion. Highly crosslinked systems, crystalline polymers or polymers with glass-like solidification lack flowable components and are therefore in general devoid of tack or possess only little tack at least.

The proportional elastic resilience forces are necessary for the attainment of cohesion. They are brought about, for example, by very long-chain macromolecules with a high degree of entanglement, and also by physically or chemically crosslinked macromolecules, and they permit the transmission of the forces that act on an adhesive bond. As a result of these resilience forces, an adhesive bond is able to withstand a long-term load acting on it, in the form of a long-term shearing load, for example, sufficiently over a relatively long time period.

For the more precise description and quantification of the extent of elastic and viscous components, and also of the ratio of the components to one another, the variables of storage modulus (G′) and loss modulus (G″) can be employed, and can be determined by means of Dynamic Mechanical Analysis (DMA). G′ is a measure of the elastic component, G″ a measure of the viscous component of a substance. Both variables are dependent on the deformation frequency and the temperature.

The variables can be determined with the aid of a rheometer. In that case, for example, the material under investigation is exposed in a plate/plate arrangement to a sinusoidally oscillating shearing stress. In the case of instruments operating with shear stress control, the deformation is measured as a function of time, and the time offset of this deformation relative to the introduction of the shearing stress is measured. This time offset is referred to as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is as follows: G″=(τ/γ)·sin(δ) (τ=shear stress, γ=deformation, δ=phase angle=phase shift between shear stress vector and deformation vector).

A composition is considered in general to be pressure-sensitively adhesive, and is defined in the sense of the invention as such, if at room temperature—presently, by definition, 23° C.—in the deformation frequency range from 10⁰ to 10¹ rad/sec, G′ is located at least partly in the range from 10³ to 10⁷ Pa, and G″ likewise lies at least partly in this range. “Partly” means that at least one section of the G′ curve lies within the window described by the deformation frequency range from 10⁰ inclusive up to 10¹ inclusive rad/sec (abscissa) and by the G′ value range from 10³ inclusive up to 10⁷ inclusive Pa (ordinate). For G″ this applies correspondingly.

The term “(meth) acrylic ester” is understood according to general opinion to encompass both acrylic esters and methacrylic esters. Similar comments apply in respect of the designation “(meth)acrylate”.

The iso index is a measure or, in the case of isomer mixtures, an average value for the branching of the alcohol radicals in the (meth)acrylate comonomers, and is defined as the number of methyl groups (—CH₃) in the primary alcohol minus 1 (see WO 2013/048945 A1). For determining the iso index, the free alcohol of the (meth)acrylic esters is reacted with trichloroacetyl isocyanate to form a carbamate, and a calculation is conducted in accordance with equation 1 below:

$$iso index = \frac{\frac{I ( {CH}_{3} )}{3}}{\frac{I ( {CH}_{2} - OR )}{2}} - 1 \qquad [ 1 ]$$

The degree of branching can be determined by ¹H-NMR spectroscopic analysis of the alcohol or alcohol mixture. I(CH₃) in equation 1 denotes the absolute peak area, determined by integration, of the methyl protons (δ in the range between 0.70 and 0.95 ppm), and I(CH₂—OR) denotes the absolute peak area of the methylene protons in α-position to the carbamate (δ in the range between 3.9 and 4.5 ppm) of the derivatized alcohol. An iso index of 1 means that the alcohol residue has exactly one branching point.

Preferred (meth)acrylic esters having a homopolymer glass transition temperature of not more than −60° C. and an alcohol component based on a branched, primary alcohol having an iso index of 1 are, for example, 2-propylheptyl acrylate (PHA) and isodecyl acrylate.

The PSA of the invention is preferably crosslinked thermally using at least one epoxycyclohexyl derivative in the absence of proton acceptors, electron pair donors and electron pair acceptors. Thermal crosslinking produces advantageous, homogeneous crosslinking through the entire layer of adhesive, whereas with radiation-crosslinked adhesives, for example, a crosslinking profile is observed, with a crosslinking density decreasing towards the interior of the adhesive. A homogeneously crosslinked PSA layer allows uniform distribution of stresses as may occur when the bond is subjected to loading. Adhesive and cohesive properties can be balanced very precisely for the layer as a whole, allowing robust bonds with precisely forecastable profiles of properties to be obtained. With particular preference the PSA of the invention is crosslinked thermally using at least one epoxycyclohexyl derivative in the absence of any crosslinking accelerators.

The polymer A preferably has a weight-average molecular weight M_{w} of at least 500 000 g/mol, more preferably of at least 700 000 g/mol. Likewise preferably, the polymer A has a weight-average molecular weight M_{w} of not more than 1 700 000 g/mol. The polydispersity PD, i.e. the breadth of the molar mass distribution, determined as a ratio of the weight-average molecular weight M_{w} to the number-average molecule weight Mₙ, is, for the polymer A, preferably 10≦PD≦100, more preferably 20≦PD≦80.

The PSA of the invention further comprises at least one synthetic rubber. In accordance with the invention, the synthetic rubber or rubbers is or are present in the PSA at not less than 5 wt %, more preferably at 5 to 30 wt %, based on the total weight of the PSA. With particular preference the PSA contains 7.5 to 25 wt %, more particularly 10 to 22.5 wt %, of at least one synthetic rubber, based in each case on the total weight of the PSA. Where there are two or more synthetic rubbers in the PSA of the invention, the aforementioned weight fractions apply to the entirety of these synthetic rubbers.

The weight ratio of polyacrylates A to synthetic rubbers in the PSA of the invention is preferably 2:1 to 15:1, more preferably 2.2:1 to 9.5:1, more particularly 2.5:1 to 7:1.

At least one synthetic rubber in the PSA of the invention is preferably a block copolymer having an A-B, A-B-A, (A-B)ₙ, (A-B)ₙX or (A-B-A)ₙX structure,

in which
the blocks A independently of one another are a polymer formed by polymerization of at least one vinylaromatic;
the blocks B independently of one another are a polymer formed by polymerization of conjugated dienes having 4 to 18 C atoms and/or isobutylene, or are a partly or fully hydrogenated derivative of such a polymer;
X is the residue of a coupling reagent or initiator; and
n is an integer 2.

More particularly, all synthetic rubbers in the PSA of the invention are block copolymers having a structure as set out above. The PSA of the invention may therefore also comprise mixtures of different block copolymers having a structure as above.

Preferred block copolymers (vinylaromatic block copolymers) thus comprise one or more rubber-like blocks B (soft blocks) and one or more glass-like blocks A (hard blocks). With particular preference, at least one synthetic rubber in the PSA of the invention is a block copolymer having an A-B, A-B-A, (A-B)₃X or (A-B)₄X structure, with A, B and X being as defined above. Very preferably, all synthetic rubbers in the PSA of the invention are block copolymers having an A-B, A-B-A, (A-B)₃X or (A-B)₄X structure, with A, B and X being as defined above. More particularly, the synthetic rubber in the PSA of the invention is a mixture of block copolymers having an A-B, A-B-A, (A-B)₃X or (A-B)₄X structure, preferably comprising at least diblock copolymers A-B and/or triblock copolymers A-B-A.

The block A is generally a glass-like block having a preferred glass transition temperature (Tg) which is above room temperature. With particular preference the Tg of the glass-like block is at least 40° C., more particularly at least 60° C., very preferably at least 80° C., and most preferably at least 100° C. The fraction of vinylaromatic blocks A in the block copolymers as a whole is preferably 10 to 40 wt % , more preferably 15 to 33 wt %. Vinylaromatics for the construction of the block A include preferably styrene, α-methylstyrene and/or other styrene derivatives. The block A may therefore take the form of a homopolymer or copolymer. With particular preference the block A is a polystyrene.

The vinylaromatic block copolymer further generally has a rubber-like block B or soft block, having a preferred Tg of less than room temperature. The Tg of the soft block is more preferably less than 0° C., more particularly less than −10° C., for example less than −40° C. and very preferably less than −60° C.

Preferred conjugated dienes as monomers for the soft block B are, in particular, selected from the group consisting of butadiene, isoprene, ethylbutadiene, phenylbutadiene, piperylene, pentadiene, hexadiene, ethylhexadiene, dimethylbutadiene and the farnesene isomers, and also any desired mixtures of these monomers. Block B as well may take the form of a homopolymer or a copolymer.

With particular preference the conjugated dienes as monomers for the soft block B are selected from butadiene and isoprene. For example, the soft block B is a polyisoprene, a polybutadiene or a partly or fully hydrogenated derivative of one of these two polymers, such as, in particular, polybutylene-butadiene, or is a polymer of a mixture of butadiene and isoprene. Very preferably the block B is a polybutadiene.

The PSA of the invention further comprises at least one peel adhesion-reinforcing resin.

The peel adhesion-reinforcing resin is preferably a hydrocarbon resin which is compatible with the synthetic rubber(s). “Compatible” means that at a molecular level, the resin dissolves in the polymer in question and does not form domains, resulting only in a mixed glass transition temperature composed of the glass transition temperatures of the polymer and of the resin. The hydrocarbon resin compatible with the synthetic rubber(s) is preferably selected from the group consisting of hydrogenated polymers of dicyclopentadiene; unhydrogenated or partially, selectively or fully hydrogenated hydrocarbon resins based on C5, C5/C9 or C9 monomers; and polyterpene resins based on a-pinene and/or on β-pinene and/or on δ-limonene, and also mixtures of the above hydrocarbon resins. The hydrocarbon resins compatible with the synthetic rubber(s) are preferably not compatible with the polyacrylates in the PSA of the invention. The aromatic fraction ought therefore not to be too high. The poly(meth)acrylate phase(s) of the PSA of the invention are therefore preferably free from peel adhesion-reinforcing resins.

The hydrocarbon resin compatible with the synthetic rubber in the PSA of the invention preferably has a DACP of at least 0° C., very preferably of at least 20° C., and/or preferably a MMAP of at least 40° C., very preferably of at least 60° C. Concerning the determination of MMAP and DACP, reference is made to C. Donker, PSTC Annual Technical Seminar, Proceedings, pp. 149-164, May 2001.

Where there are two or more hydrocarbon resins compatible with the synthetic rubber in the PSA of the invention, the details above preferably apply to all of the synthetic rubber-compatible hydrocarbon resins present in the PSA of the invention.

Hydrocarbon resins compatible with the synthetic rubber(s) are present in the PSA of the invention preferably at a level in total of 10 to 30 wt %, more preferably in total 15 to 25 wt %, based on the total weight of the PSA.

A further subject of the invention is an adhesive tape which comprises a foamed carrier and a PSA of the invention. The foamed carrier preferably comprises a syntactic polymer foam. The term “syntactic foam” describes a special form of a closed-cell foam whose voids are formed by hollow glass beads, hollow ceramic beads and/or hollow polymer beads.

On the reverse of the syntactic polymer foam layer, for stabilization and/or for lining, there may be, for example, a liner or a conventional film material provided, thus giving at least one three-layer system comprising the at least two-layer adhesive tape of the invention.

Given polymer foam layers that are sufficiently thick, the side of the polymer foam layer that is facing away from the PSA layer, and that in two-layer systems is exposed, may also be stabilized by being highly crosslinked by a crosslinking operation with a low depth of penetration, so that only part of the foam carrier layer is highly crosslinked, whereas, on the other side of the carrier, facing towards the PSA layer, the viscoelastic properties originally present are retained.

With particular preference there is a PSA arranged on both sides of the foamed carrier, with one of the PSAs being a PSA of the invention. More particularly a PSA of the invention is disposed on both sides of the foamed carrier. This is advantageous since in this case, both sides of the adhesive tape have the advantageous technical adhesive properties of the PSA of the invention.

In one specific embodiment, there is a PSA disposed on both sides of the foamed carrier, and the two PSAs contain identical additives in identical concentration, more particularly functional additives and/or fillers. Similarly, both PSAs may also be free from functional additives and/or fillers. In one particular embodiment there is a PSA, more particularly a PSA of the invention, disposed on both sides of the foamed carrier, and the PSAs are identical chemically, physically and/or in their extents. More particularly, both PSAs are completely identical, leaving aside insubstantial mismatches, of the kind which may result, for example, from impurities within the realm of the omnipresent concentration, from production-related inaccuracies, and from similar other sources.

The foamed carrier preferably comprises at least 50 wt %, based on the total weight of the foam, of at least one polymer selected from the group consisting of rubbers, more particularly natural rubbers, polyurethanes, poly(meth)acrylates and styrene block copolymers, and also blends of the stated polymers. More preferably the foamed carrier contains at least 50 wt % of one or more poly(meth)acrylates, based on the total weight of the foam.

In particular the foamed carrier contains at least 50 wt %, based on the total weight of the foam, of at least one poly(meth)acrylate B which can be traced back to the following monomer composition:

b1) 65 to 97 wt % of ethylhexyl acrylate and/or butyl acrylate,

b2) 0 to 30 wt % of methylacrylate,

b3) 3 to 15 wt % of acrylic acid.

The polymer or polymers present in the foamed carrier, more preferably the polymer B, has or have a weight-average molecular weight M_{w} of at least 500 000 g/mol, more preferably of at least 700 000 g/mol. Likewise preferably, the polymers in the foamed carrier have a weight-average molecular weight M_{w} of not more than 1 700 000 g/mol. The polydispersity PD, i.e. the breadth of the molar mass distribution, which is determined as the ratio of the weight-average molecular weight M_{w} to the number-average molecular weight Mₙ, for the polymers present in the foamed carrier, is preferably 10≦PD≦100, more preferably 20≦PD≦80.

Where the terms top face and bottom face are used in the context of this specification, they serve merely for a local differentiation between the two surfaces of the foamed carrier, and are not intended, over and above this, to contain any further directional information. On the “top face”, therefore, means, in particular, on one of the sides of the corresponding layer, while on the bottom face means on the other side of the corresponding layer.

The polymers used in the construction of the adhesive tape of the invention can be prepared outstandingly by a free radical polymerization, preferably in solution, in accordance with the prior art. In the case of optional subsequent processing from the melt, the solvent is stripped off after the polymerization.

The foamed carrier is preferably shaped to the layer from the melt. The PSA of the invention as well is preferably shaped from the melt; given that PSA layers are customarily produced only in layer thicknesses of up to 100 μm, the PSA of the invention may also be coated from solution and dried thereafter. With particular preference all of the poly(meth)acrylate compositions used in the construction of the adhesive tape of the invention are produced, processed and coated in a hotmelt process.

Regarding the definition of a melt of an amorphous polymer such as of a poly(meth)acrylate, for example, the invention uses the criteria which are employed in F. R. Schwarzl, Polymermechanik: Struktur and mechanisches Verhalten von Polymeren [Polymer mechanics: Structure and mechanical behaviour of polymers], Springer Verlag, Berlin, 1990, on pages 89 ff., namely that the viscosity has an order of magnitude of approximately η10⁴ Pas and the internal damping achieves tan δ values of ≧1.

Where certain layers of the adhesive tape of the invention are produced by coating from the melt, but for homogeneous distribution of thermal crosslinkers for initiating a subsequent thermal crosslinking these same crosslinkers have to be added prior to coating, the problem arises that the thermal crosslinkers are exposed to the high temperatures for generating the polymer melt and they therefore trigger uncontrolled polymer crosslinking (known as gelling) even prior to coating. In order largely to suppress this gelling, the hotmelt process customarily uses crosslinkers which are very slow to react, and only uses them shortly prior to coating. In order nevertheless to achieve satisfactory crosslinking outcomes after coating, preference is given to admixing what are known as “accelerators”.

For polymer systems which are coated from solution and are to be crosslinked thermally as well, the use of accelerators may make sense and is frequently practised. The thermally initiated crosslinking operation is customarily associated with the thermal removal of the solvent from the applied layer, i.e. the drying of the layer of composition. Excessively rapid removal of the solvent in this case results in a poorly formed, uneven layer, owing to blistering, for example. For this reason, drying is carried out at moderate temperatures. In order nevertheless to guarantee effective crosslinking which proceeds with sufficient rapidity, even at these temperatures, accelerators may also be added to the solvent systems.

Now coating from solution is frequently preferred when the thickness of the resulting layers is not very great, meaning that there are no significant problems associated with increased viscosity of the polymer solution to be applied (in comparison to a largely solvent-free melt).

As accelerators or else substance with an accelerating effect, use is made in particular of photon acceptors, electron-pair donors (Lewis bases) and/or electron-pair acceptors (Lewis acids). Accelerators are compounds or chemicals which support crosslinking reactions by ensuring sufficient reaction rate. This is accomplished, in particular, catalytically (by activation of the crosslinking reaction) and/or by conversion of functional groups in the crosslinker substances or the macromolecules to be crosslinked into functional groups which are able to react in such a way as to link the macromolecules to one another (bridging, network formation) or to other functional groups.

The accelerators themselves do not participate in a linking reaction of this kind (that is, they do not themselves crosslink), but are ultimately able to be incorporated into the network or attached to it, in the form of reaction products or of fragments. The accelerator thus ensures a substantial improvement in the kinetics of the crosslinking reaction.

Crosslinkers, in contrast, are substances which are able through their own functional groups to participate in a reaction, more particularly an addition or substitution reaction, which leads via bridging to a network. Additionally present may be functional groups which—as a result of the aforementioned acceleration or by other processes, for example—are converted in the course of the crosslinking reaction into functional groups which then lead to bridging between the macromolecules of the polymers to be crosslinked.

Given selected reaction parameters, here in particular a temperature below the processing temperature of the polyacrylates, the crosslinking reaction would not proceed, or would only proceed with insufficient slowness, in the absence of the accelerator. Many epoxides which are used as crosslinkers are inherently relatively slow to react, and so without accelerators do not lead to satisfactory crosslinking outcomes.

Proton donors, especially carboxylic acids and/or carboxylic acid groups and/or protonated derivatives thereof, are not counted as accelerators in the sense of the invention.

The presence of accelerators in the PSA of the invention and/or in the foamed carrier may also, however, have drawbacks. For instance, nitrogen-containing accelerators in particular, such as amines, for example, tend to yellow over time as a result of oxidation processes, meaning that accelerator systems of this kind are poorly suited or completely unsuited in particular to transparent or white PSAs or multi-layer pressure-sensitive adhesive tapes.

Accelerators which are salt-like or which form salts (especially basic accelerators), such as the aforementioned amines or else zinc chloride, for instance, may lead to a product of increased moisture capacity, since salts generally possess hygroscopic properties. Especially for PSAs which are to have very high resistance to combined heat and humidity, in view of the intended sector of use, accelerators of this kind are less suitable.

In accordance with the invention, therefore, the aim is to achieve thermal crosslinking particularly of the PSA or PSAs of the invention that are in air contact with epoxycyclohexyl derivatives without admixing of accelerators. The absence here relates in particular to externally added accelerators (i.e. accelerators which are not copolymerized and/or not incorporated into the polymer framework); with particular preference, however, neither externally added nor copolymerized accelerators are present—in other words, no accelerators at all.

The nature of the polymer-based layers and their physical properties (for example viscoelasticity, cohesion, elastic component) may be influenced through the nature and the degree of crosslinking.

The PSA of the invention is preferably crosslinked thermally by at least one epoxycyclohexyl derivative. More preferably the PSA of the invention is crosslinked thermally by one or more epoxycyclohexyl carboxylates, especially (3,4-epoxycyclohexane)methyl 3,4-epoxycyclohexylcarboxylate (CAS 2386-87-0).

In the composition for producing the PSA of the invention, the epoxycyclohexyl derivate crosslinker or crosslinkers is or are present preferably in a total amount of up to 0.4 part by weight, more preferably of up to 0.3 part by weight, based in each case on 100 parts by weight of polymer to be crosslinked (therefore, if no other additives are admixed to the PSA, based on 100 parts by weight of PSA to be crosslinked). With crosslinker quantities of more than 0.4 part by weight per 100 parts by weight of polymer, detractions from the peel adhesion are increasingly likely, and there is a dramatic deterioration in the wetting. Especially preferred crosslinker fractions are situated, for example, in the range from 0.12 to 0.30 part by weight, more particularly in the range from 0.15 to 0.25 part by weight (per 100 parts by weight of polymer).

Where the PSA of the invention comprises one or more accelerators, they are present preferably at 0.1 to 1.5 parts by weight, preferably at 0.15 to 1.2 parts by weight, based on 100 parts by weight of polymer to be crosslinked.

The foamed carrier as well is preferably crosslinked thermally, leading to very homogeneous formation of the viscoelastic layer. With particular preference the foamed carrier is crosslinked thermally by one or more glycidyl ethers, more particularly by one or more polyglycidyl ethers, very preferably by pentaerythritol tetraglycidyl ether (CAS 3126-63-4). Crosslinking takes place more particularly in combination with an amine, more preferably with isophoronediamine (CAS 2855-13-2), as accelerator. In the composition for producing the foamed carrier, the crosslinker or crosslinkers is or are present preferably at up to 1.0 part by weight, more preferably up to 0.8 part by weight, per 100 parts by weight of polymer to be crosslinked. Especially preferred crosslinker fractions are situated, for example, in the range from 0.05 to 0.6, more particularly from 0.10 to 0.5, part by weight, per 100 parts by weight of polymer to be crosslinked.

In the composition for producing the foamed carrier, the accelerator or accelerators are present preferably at 0.1 to 1.5 parts by weight, more preferably at 0.15 to 1.2 parts by weight, based on 100 parts by weight of polymer to be crosslinked.

In the case of three-layer or multi-layer constructions in particular, the presence of an amine accelerator in the foamed carrier layer is not critical, since in these cases the carrier layer is largely shielded by the external PSA layers from the influence of oxidizing substances such as atmospheric oxygen, for instance.

Thermal crosslinking of the foamed carrier layer and of the PSA layer or layers of the invention may be carried out simultaneously, if, for instance, the PSA layers are coated onto the as yet uncrosslinked carrier layer or if the layers are shaped together in a common process.

However, the individual layers may also be thermally crosslinked in separate processes, if, for instance, the PSA layers are coated onto the foamed carrier layer after it has already been thermally crosslinked, and are then thermally crosslinked, or if the PSA layers are shaped at a different location and crosslinked thermally—on a temporary carrier such as a release material, for instance—and then laminated onto the foamed carrier layer that has already been crosslinked. For the latter in particular it may be advantageous to carry out chemical and/or physical pretreatment of the foamed carrier layer and/or of the PSA layer(s), by means, for example, of corona treatment and/or plasma treatment and/or reactive corona treatment and/or reactive plasma treatment, using gases such as nitrogen, oxygen, fluorine and/or others and/or by means of flame treatment.

Double-sided, more particularly three-layer, adhesive tapes of the invention may also be produced as set out for three-layer and multi-layer systems in WO 2006 027 389 A1. The production and coating methods described therein may also be employed analogously for the adhesive tapes of the present specification; the disclosure content of WO 2006 027 389 A1 is therefore explicitly included in the present disclosure content, with the same applying to the description of the product constructions in WO 2006 027 389 A1.

Foaming with microballoons in order to produce the foamed carrier layer is accomplished preferably in accordance with the processes described in EP 2 414 143 A1 and DE 10 2009 015 233 A1.

The foamed carrier is preferably regarded as a liquid of very high viscosity which under compressive loading exhibits flow behaviour (also referred to as “creeping”). Viscoelastic compositions in this sense preferably have a capacity simply by virtue of the force of gravity, in other words under loading from their intrinsic weight, of flowing more or less slowly and in particular of flowing onto a substrate or of wetting a substrate. At least, however, this effect occurs under an external pressure exposure. Any increase in pressure, by pressing of the adhesive tape onto the substrate, for instance, may significantly accelerate this behaviour.

Viscoelastic materials in the sense of the above-described, preferred foamed carrier further possess the capacity, under slow exposure to force, to relax the forces which act on them. They are therefore capable of dissipating the forces into vibrations and/or deformations, which may also—at least partly—be reversible, and hence of “buffering” the acting forces and of preferably avoiding mechanical destruction by the acting forces, but at least of reducing such destruction or else at least delaying the time of onset of the destruction. In the case of a very fast-acting force, viscoelastic materials customarily exhibit elastic behaviour, in other words the behaviour of a fully reversible deformation, and forces which exceed the elasticity of the material may result in fracture.

In contrast to these are elastic materials, which exhibit the described elastic behaviour even under slow exposure to force. Elastic behaviour, fundamentally, has adverse consequences for the wetting. It is therefore advantageous for the PSAs of the invention as well, in spite of a pronouncedly elastic behaviour, to tend to exhibit viscoelastic behaviour overall under rapid force loading, to behave more viscously like a fluid, in particular over a long time scale, and hence to bring about optimum and—in particular—rapid wetting.

Suitable additives for one or more layers of the adhesive tape of the invention, especially for the foamed carrier layer, are hollow polymer beads, solid polymer beads, hollow glass beads, solid glass beads, hollow ceramic beads, solid ceramic beads, and solid carbon beads (carbon microballoons).

Particularly preferred additives especially in the foamed carrier, but also in the PSA of the invention, are foaming agents. Preferred foaming agents are expandable hollow polymeric microstructures which may optionally also be used in the fully expanded state. Particularly preferred are hollow microstructures which are able to expand on supply of heat and/or other energy, more particularly gas-filled and/or liquid-filled polymer beads whose shell is made, for example, of a thermoplastic material such as polymethyl methacrylate, polyacrylonitrile, PVDC or polystyrene.

The addition of silicas, advantageously of precipitated silica surface-modified with dimethyldichlorosilane, can be utilized in order to increase the thermal shear strength of the corresponding polymer-based layer, especially of the foamed carrier layer. Such silicas can also be used outstandingly for transparent products. For transparent adhesive tapes in particular it is useful if the silica is added in a fraction of up to 15 parts by weight per 100 parts by weight of polymer.

In all layers of the adhesive tape of the invention, especially in the PSA layer of the invention, plasticizers may optionally be present. Preferred plasticizers are (meth)acrylate oligomers, phthalates, cyclohexanedicarboxylic esters (e.g. Hexamoll® DINCH, BASF, CAS 166412-78-8), water-soluble plasticizers, plasticizing resins, phosphates (e.g. Levagard® DMPP, Lanxess, CAS 18755-43-6) and polyphosphates.

An adhesive tape of the invention—especially in its preferred embodiments—has significant differences from the adhesive tapes of the prior art:

As a result of the thermal crosslinking, the pressure-sensitive adhesive tape has no crosslinking profile through its layers. Viscoelastic layers and also PSA layers crosslinked by actinic radiation (ultraviolet radiation, electron beams) exhibit a crosslinking profile through the respective crosslinked layer. Thermally crosslinked adhesive layers do not display this feature, since the heat is able to penetrate uniformly into the layer.

The absence of the accelerator substances may be detected analytically. Systems crosslinked in the presence of accelerator have residues of these accelerators, such as, for instance, nitrogen compounds in the case of amine accelerators, zinc chloride or the like.

It has further been possible to show that polyacrylate PSAs of the invention crosslinked thermally by means of epoxycyclohexyl derivatives have a higher peel adhesion than the systems crosslinked by other crosslinkers. This quality can probably be attributed to a specific crosslinking structure. This difference also has consequences for the adhesive tapes of the invention. If a viscoelastic poly(meth)acrylate foam layer is used and if it is furnished on at least one side with the blend PSA of the invention, crosslinked thermally, in particular with an epoxycyclohexyl derivative, then not only the peel adhesion but also the wetting behaviour on this adhesive tape side are once again higher or better than for systems which
have the corresponding PSA on an elastic polymer carrier (conventional foam carriers such as PE, for example) or
have the same viscoelastic carrier, but a different PSA, even one which per se is significantly more tacky.

The peel adhesion of the adhesive tape is therefore affected not only by the external PSA, but also, likewise, by the foamed carrier, meaning that the system as a whole is important for the outstanding adhesive properties. One preferred embodiment of the adhesive tape of the invention therefore comprises the combination of a viscoelastic polyacrylate foam layer with a PSA layer which per se (in other words, for example, with elastic film substrates as carriers) is not strongly pressure-sensitively adhesive, the adhesive behaviour with respect to the substrates being optimized through interaction of these two layers. Peel adhesion and wetting behaviour are therefore achieved which are frequently much better than in the case of PSAs which per se have a high pressure-sensitive adhesiveness, more particularly those adhesives which are present on conventional elastic carriers.

An adhesive tape of the invention may be provided on one or else on both sides with a release material. The release materials may, for example, be silicones, films, siliconized films or papers, surface-treated films or papers, or the like; essentially, therefore, what are called (release) liners.

The adhesive tapes of the invention may also comprise further layers, hence having a number of layers greater than three. It is preferred if in this case the foamed carrier layer is furnished at least indirectly, more preferably directly, with a PSA layer of the invention, in order to produce the aforementioned improvement in key technical adhesive properties.

A feature of the pressure-sensitive adhesive tapes of the invention is that they can be provided as very thick products which also possess very high peel adhesion. Such products find application, for example, in the building sector, in the automotive industry, or for adhesive bonds which are intended to compensate unevennesses or cavities. The adhesive tapes of the invention can be produced in customary thicknesses of several to several hundred micrometres, or else advantageously in thicknesses of more than 300 μm, for example 500 μm or more, 1000 μm or more, 1500 μm or more, 2000 μm or more or else 3000 μm or more. Products even thicker can also be realized.

On account of the good relaxation behaviour of the foamed carrier layer, the adhesive tapes of the invention are suitable for absorbing forces such as mechanical stresses, impacts and the like and of dissipating the energy. The adhesive tapes of the invention are therefore also highly suitable wherever there is a requirement for an impact-damping and/or vibration-damping effect, as in the bonding, for instance, of fragile articles, in electronic applications and the like. The adhesive tapes of the invention can be deployed with particular advantage if materials having different coefficients of thermal expansion are to be bonded to one another, since the adhesive tapes of the invention, by means of their relaxation properties, are able to dissipate stresses which result under hot conditions from the different expansion behaviour of the interbonded articles or surfaces. Here, conventional adhesive tapes frequently tend to fail—that is, there is a weakening or even a fracture of the bond site.

It has been found that on the one hand the thickness of the PSA layer provided on the relevant adhesive tape side, but also the thickness of the underlying foamed carrier layer, have a greater or lesser influence on the bond strength of a respective side of the adhesive tape of the invention.

The PSAs of the invention are present preferably in a layer thickness of up to 100 μm, more preferably of up to 75 μm, very preferably of up to 50 μm. The foamed carrier layer, in combination therewith, preferably has a thickness of at least 400 μm, more preferably at least 900 μm, very preferably at least 1400 μm, more particularly at least 1900 μm, and especially preferably at least 2400 μm.

Adhesive tapes of the invention also have good moisture resistance and resistance to combined heat and humidity. They possess very high peel adhesion; evidently, then, success has been achieved in “distributing” over two different layers the properties of flow behaviour and cohesion that are needed for good adhesives, and hence in being able to realize more effective fine tuning of these properties. The good flow properties of the viscoelastic carrier layer, especially if it is based on poly(meth)acrylate, result in effective flow of the product as a whole onto the substrate. Consequently, the PSA layer(s) can be provided with relatively high cohesion without any adverse effect overall on the peel adhesion of the adhesive tape.

The adhesive tapes of the invention are especially suitable for the bonding and fastening of decorative trim, emblems and bumpers on apolar automotive finishes. If required, these finishes can also be treated with a primer prior to bonding, in order to achieve an even further increase in the strength of bonding.

Other areas of application ideally suited to the adhesive tapes of the invention are, for example, construction of buildings, extension of buildings, equipping of buildings and, generally, the architectural sector, both inside and/or out; the DIY sector, model construction, furniture making, shipbuilding and aircraft construction; the electronic and electrical industries, for consumer electronics, for example, including white goods and brown goods, and red goods as well in view of the high thermal stability; and also for traffic safety, such as road signage and the like.

Experimental Section

Measurement Methods:

Solids Content (Method A1):

The solids content is a measure of the fraction of unevaporable constituents in a polymer solution. It is determined gravimetrically, with the solution being weighed, then the vaporizable fractions being evaporated off in a drying cabinet at 120° C. for 2 hours, and the residue weighed again.

K Value (According to Fikentscher) (Method A2):

The K value is a measure of the average molecule size in high-polymer compounds. For the measurement, one per cent strength (1 g/100 ml) toluenic polymer solutions were prepared, and their kinematic viscosities were determined using a Vogel-Ossag viscometer. Following standardization to the viscosity of toluene, the relative viscosity is obtained, and can be used to calculate the K value according to Fikentscher (Polymer 1967, 8, 381 ff.).

Gel Permeation Chromatography GPC (Method A3):

The figures in this specification for the weight-average molecular weight M_{w} and the polydispersity PD relate to the determination by gel permeation chromatography. The determination takes place on 100 μl samples subjected to clarifying filtration (sample concentration 4 g/l). The eluent used is tetrahydrofuran with 0.1 vol % of trifluoroacetic acid. Measurement takes place at 25° C. The preliminary column used is a PSS-SDV column, 5μ, 10³ Å, ID 8.0 mm×50 mm. Separation takes place using the columns PSS-SDV, 5μ, 10³ Å and also 10⁵ Å and 10⁶ Å, each of ID 8.0 mm×300 mm (columns from Polymer Standards Service; detection using Shodex R171 differential refractometer). The flow rate is 1.0 ml per minute. Calibration takes place against PMMA standards (polymethyl methacrylate calibration).

Density Determination From the Coatweight and the Layer Thickness (Method A4):

The weight per unit volume or density p of a coated self-adhesive composition is determined via the ratio of the weight per unit area to the respective layer thickness:

$$ρ = \frac{m}{V} = \frac{MA}{d} \\ [ ρ ] = \frac{[ kg ]}{[ {m}^{2} ] \cdot [ m ]} = [ \frac{kg}{{m}^{3}} ]$$

MA=coatweight/weight per unit area (excluding liner weight) in [kg/m²]

d=layer thickness (excluding liner thickness) in [m]

This method gives the unadjusted density.

This density determination is suitable in particular for determining the total density of finished products, including multi-layer products.

180° Peel Adhesion Test (Method H1):

A strip 20 mm wide of an acrylate PSA applied as layer to polyester was applied to steel plates which beforehand had been washed twice with acetone and once with isopropanol. The pressure-sensitive adhesive strip was pressed onto the substrate twice with an applied pressure corresponding to a weight of 2 kg. The adhesive tape was then immediately removed from the substrate with a velocity of 300 mm/min and at an angle of 180°. All measurements were conducted at room temperature.

The results are reported in N/cm and have been averaged from three measurements.

Holding Power (Method H2):

A strip of the adhesive tape 13 mm wide and more than 20 mm long (30 mm for example) was applied to a smooth steel surface which had been cleaned three times with acetone and once with isopropanol. The bonding area was 20 mm×13 mm (length×width), with the adhesive tape overhanging the test plate (for example by 10 mm in accordance with above-stated length of 30 mm). The adhesive tape was then pressed onto the steel support four times with an applied pressure corresponding to a weight of 2 kg. This sample was suspended vertically, so that the projecting end of the adhesive tape pointed downwards.

At room temperature a weight of e.g. 1 kg (10 N) was affixed to the projecting end of the adhesive tape; the respective weight is given again in the examples. Measurement was conducted under standard conditions (23° C., 55% atmospheric humidity) and at 70° C. in a heating cabinet.

The holding powers measured (times which elapse before complete detachment of the adhesive tape from the substrate; measurement discontinued after 10 000 minutes) are reported in minutes and correspond to the average of three measurements.

Microshear Test (Method H3):

This test is used for accelerated testing of the shear strength of adhesive tapes under temperature load.

Measurement Sample Preparation for Microshear Test:

An adhesive tape (length about 50 mm, width 10 mm) cut from the respective sample specimen is adhered to a steel test plate, which had been cleaned with acetone, in such a way that the steel plate protrudes to the right and left beyond the adhesive tape and that the adhesive tape protrudes beyond the test plate at the upper edge by 2 mm. The bond area of the sample in terms of height×width=13 mm×10 mm. The bond site is subsequently rolled down six times with a 2 kg steel roller at a speed of 10 m/min. The adhesive tape is reinforced flush with a stable adhesive strip which serves as a support for the travel sensor. The sample is suspended vertically by means of the test plate.

Microshear Test:

The sample specimen for measurement is loaded at the bottom end with a 1000 g weight. The test temperature is 40° C., the test duration 30 minutes (15 minutes of loading and 15 minutes of unloading). The shear travel after the predetermined test duration at constant temperature is reported as the result, in _82 m, as both the maximum value [“max”; maximum shear travel as a result of 15-minute loading] and as the minimum value [“min”; shear travel (“residual deflection”) 15 minutes after unloading; on unloading there is a movement back as a result of relaxation]. Likewise reported is the elastic component in per cent [“elast”; elastic component=(max−min)×100/max].

90° Peel Adhesion on Steel—Open and Lined Sides (Method M1):

The peel adhesion on steel was determined under test conditions of 23° C.+/−1° C. temperature and 50%+/−5% relative atmospheric humidity. The specimens were cut to a width of 20 mm and adhered to a steel plate. Prior to the measurement, the steel plate was cleaned and conditioned. This was done by first wiping the plate with acetone and then leaving it to lie in the air for 5 minutes so that the solvent could evaporate.

Three-Layer Assembly:

The side of the three-layer assembly facing away from the test substrate was then lined with a 50 μm aluminium foil, to prevent the specimen stretching in the course of the measurement. After that, the test specimen was rolled onto the steel substrate. For this purpose, a 2 kg roller was passed five times back and forth over the tape with a rolling speed of 10 m/min. Immediately after rolling, the steel plate was inserted into a special mount which allows the specimen to be peeled off vertically upwards at an angle of 90°. Peel adhesion measurement was carried out using a tensile tester from Zwick. When the lined side was applied to the steel plate, the open side of the three-layer assembly was first laminated to the 50 μm aluminium foil, the release material was then removed and the assembly was adhered to the steel plate, rolled analogously, and subjected to measurement.

The results of measurement for both sides, open and lined, are reported in N/cm and have been averaged from three measurements.

Specimens on 23 μm PET Film:

The single-sided test specimen was applied to the steel substrate and then pressed down five times using a 2 kg roller with a rolling speed of 10 m/min. Immediately after rolling, the steel plate was inserted into a special mount allowing the specimen to be peeled off vertically upwards at an angle of 90°. Peel adhesion was measured using a tensile tester from Zwick. The results are reported in N/cm and are averaged from three measurements.

Holding Power—Open and Lined Sides (Method M2):

Preparation of specimens was carried out under test conditions of 23° C.+/−1° C. temperature and 50%+/−5% relative atmospheric humidity. The test specimen was cut to 13 mm and adhered to a steel plate. The bonding area was 20 mm×13 mm (length×width). Prior to the measurement the steel plate was cleaned and conditioned. This was done by first wiping the plate with acetone and then leaving it to lie in the air for 5 minutes to allow the solvent to evaporate. After bonding had been performed, the open side was reinforced with a 50 μm aluminium foil and a 2 kg roller was passed twice back and forth over the assembly. A belt loop was then placed on the projecting end of the three-layer assembly. The system was then suspended from a suitable apparatus and loaded with a weight of e.g. 1 kg (10 N); the weight is reported in each of the examples. The suspension apparatus was of a type such that the weight subjects the sample to load at an angle of 179°+/−1°. This ensured that the three-layer assembly could not peel from the bottom edge of the plate. The holding power measured, the time between the specimen being suspended and its fall, is reported in minutes and corresponds to the average from three measurements. For the measurement of the lined side, the open side was first reinforced with the 50 μm aluminium foil, the release material was then removed, and the specimen was adhered to the test plate in analogy to the description. The measurement was conducted under standard conditions (23° C., 55% humidity).

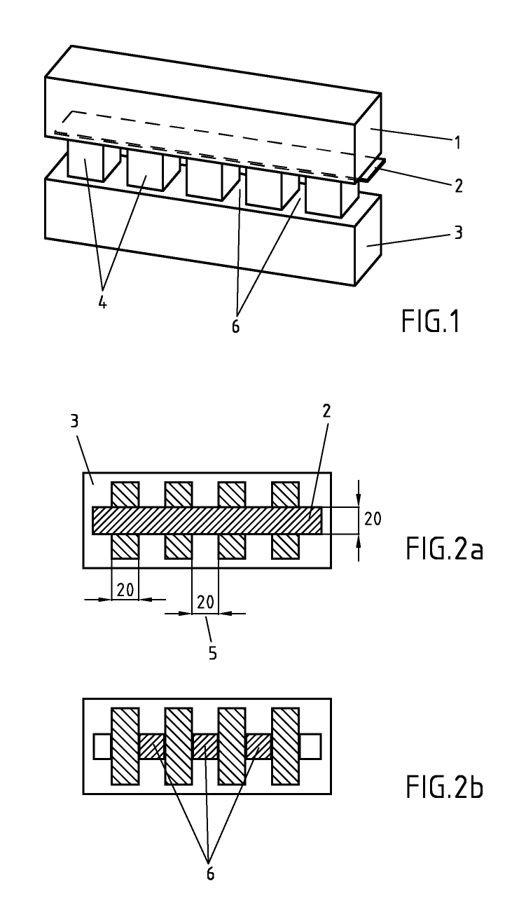

Step Wetting Test with Rigid Substrates/Rigid Rigid Wet-Out test (Method M3, FIGS. 1, 2a (View from Above) and 2b (View from Below)):

Preparation of specimens took place under test conditions of 23° C.+/−1° C. temperature and 50%+/−5% relative atmospheric humidity. Prior to the measurement, a polycarbonate plate (1, FIG. 1) was cleaned and conditioned. This was done by first wiping the plate with isopropanol and then leaving it to lie in the air for 5 minutes to allow the solvent to evaporate. The test specimen (2, FIGS. 1 and 2a) was cut to a width of 20 mm, adhered centrally to the polycarbonate plate and rolled down five times back and forth with a roller. The weight of the roller was adapted to the width of the test specimen, so that the test specimen was pressed on at 2 kg/cm; for a width of 20 mm, therefore, a 4 kg roller was used. Care was taken to ensure that the test specimen wetted the plate well. Thereafter, bonded specimens were stored for 24 hours under test conditions of 23° C.+/−1° C. temperature and 50%+/−5% relative atmospheric humidity, in order to ensure relaxation of the adhesive tape prior to further processing.

An additional polycarbonate plate (3, FIGS. 1 and 2a) was given adhesively applied steps (4, FIG. 1) with a defined height at a defined spacing (5, FIG. 2a) of 20 mm, and then cleaned and conditioned in accordance with the method described above.

Steps with heights of 20 and 100 μm were used and, as a reference, a specimen without steps was measured. The substrate (3, lower layer) with the steps bonded to it was placed on a solid substrate, with the steps pointing upwards, and the substrate (1) provided with the test specimen was placed slowly and evenly, as far as possible without pressure, onto the steps (rigid-rigid application), so that the adhesive tape was not pressed actively into the cavities (6, FIGS. 1 and 2b) between the steps. The assembled plates were subsequently rolled down uniformly once with a roller having a defined weight. The pressing speed of the roller was constant at about 2.4 m/min.

For determining the initial wetting, no step (step height 0 cm) and a 1 kg roller were used. For the step test, a step height of 100 μm and a 4 kg roller were used. In both cases a triplicate determination was carried out. When comparing different adhesive tapes, it was ensured that they had the same thickness.

For both tests, in each case after roller application, a photograph was taken of all areas between the steps (4), with a high resolution and defined illumination in a photo box, for subsequent quantification of the wetted area via a grey stage analysis by image processing software. This was done by image analysis, more specifically via an auto threshold, which utilizes the Otsu analysis. The data delivered is the fraction of the area wetted as a function of time, in [%]. The dewetting, likewise in [%], is calculated from the difference.

Commercially Available Chemicals Used

| Chemical compound | Trade name | Manufacturer | CAS No. |
|---|---|---|---|
| Bis(4-tert-butylcyclohexyl) | Perkadox ® 16 | Akzo Nobel | 15520-11-3 |
| peroxydicarbonate | | | |
| 2,2′-Azobis(2-methylpropionitrile), | Vazo ® 64 | DuPont | 78-67-1 |
| AIBN | | | |
| Acrylic acid AA (Tg = 106° C.) | — | Sigma-Aldrich | 79-10-7 |
| Butyl acrylate BA | — | BASF | 141-32-2 |
| (iso index 0, Tg = −43° C.) | | | |
| 2-Ethylhexyl acrylate EHA | — | BASF | 103-11-7 |
| (iso index 1, Tg = −58° C.) | | | |
| 2-Propylheptyl acrylate PHA | — | BASF | 149021-58-9 |
| (iso index 1, Tg = −69° C.) | | | |
| Isodecyl acrylate IDA | — | Sartomer | 1330-61-6 |
| (iso index 1, Tg = −60° C.) | | | |
| Heptadecanyl acrylate | — | BASF | — |
| (isomer mixture, iso index 3.1; | | | |
| Tg = −72° C.) | | | |
| Isobornyl acrylate IBOA | Visiomer ® IBOA | Evonik | 5888-33-5 |
| (Tg = 94° C.) | | | |
| Pentaerythritol tetraglycidyl ether | D.E.R. ® 749 | DOW | 3126-63-4 |
| 3,4-Epoxycyclohexylmethyl 3,4- | Uvacure ® 1500 | Cytec Industries | 2386-87-0 |
| epoxycyclohexanecarboxylate | | Inc. | |
| Isophoronediamine | Vestamin ® IPD | Evonik | 2855-13-2 |
| Tetraglycidyl-meta-xylenediamine | Erisys ® GA-240 | CVC | 63738-22-7 |
| Resorcinol bis(diphenyl phosphate) | Reofose ® RDP | Chemtura | 57583-54-7 |
| SBS (about 76 wt % diblock, | Kraton ® D1118 ES | Kraton | 9003-55-8 |
| block polystyrene content: 31 wt %) | | Polymers | |
| SBS (about 16 wt % diblock, | Kraton ® D1101 | Kraton | 9003-55-8 |
| block polystyrene content: 31 wt %) | | Polymers | |
| α-Pinene resin (Softening | Dercolyte A 115 | DRT | 25766-18-1 |
| temperature: about 115° C.) | | | |
| Hydrocarbon resin (based on | Piccotac 1095 | Eastman | — |
| C₅, softening point (ring & ball) | | | |
| about 95° C.) | | | |
| Microballoons (MB) | Expancel ® 051 | Expancel | |
| (Dry unexpanded microspheres, | DU 40 | Nobel | |
| diameter 9-15 μm, expansion | | Industries | |
| onset temperature 106-111° C., | | | |
| TMA density ≦25 kg/m³) | | | |

I. Preparation of Pressure-Sensitive Adhesives PA1 to PA7

Described below is the preparation of the starting polymers. The polymers investigated were prepared conventionally via a free radical polymerization in solution.

Polyacrylate PSA1 (PA1):

A 300 L reactor conventional for radical polymerizations was charged with 11.0 kg of acrylic acid, 27.0 kg of butyl acrylate (BA), 62.0 kg of 2-propylheptyl acrylate (PHA) and 72.4 kg of acetone/isopropanol (94:6). After nitrogen gas had been passed through the reactor for 45 minutes with stirring, the reactor was heated to 58° C. and 50 g of Vazo® 67 were added. The external heating bath was subsequently heated to 75° C. and the reaction was carried out constantly at this external temperature. After a reaction time of 1 hour a further 50 g of Vazo® 67 were added. Dilution took place after 3 hours with 20 kg of acetone/isopropanol (94:6) and after 6 hours with 10.0 kg of acetone/isopropanol (94:6). To reduce the residual initiators, 0.15 kg portions of Perkadox® 16 were added after 5.5 hours and again after 7 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=25 000 g/mol; M_{w}=1 010 000 g/mol. K value: 50.3.

Polyacrylate PSA2 (PA2):

A 300 L reactor conventional for radical polymerizations was charged with 11.0 kg of acrylic acid, 27.0 kg of BA, 62.0 kg of isodecyl acrylate (IDA) and 72.4 kg of acetone/isopropanol (94:6). After nitrogen gas had been passed through the reactor for 45 minutes with stirring, the reactor was heated to 58° C. and 50 g of Vazo® 67 were added. The external heating bath was subsequently heated to 75° C. and the reaction was carried out constantly at this external temperature. After a reaction time of 1 hour a further 50 g of Vazo® 67 were added. Dilution took place after 3 hours with 20 kg of acetone/isopropanol (94:6) and after 6 hours with 10.0 kg of acetone/isopropanol (94:6). To reduce the residual initiators, 0.15 kg portions of Perkadox® 16 were added after 5.5 hours and again after 7 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=31 400 g/mol; M_{w}=961 000 g/mol. K value: 49.4.

Polyacrylate PSA3 (PA3):

A 100 L glass reactor conventional for radical polymerizations was charged with 4.0 kg of acrylic acid, 12.0 kg of BA, 24.0 kg of PHA and 26.7 kg of acetone/benzine 60/95 (1:1). After nitrogen gas had been passed through the reactor for 45 minutes with stirring, the reactor was heated to 58° C. and 30 g of AIBN were added. The external heating bath was subsequently heated to 75° C. and the reaction was carried out constantly at this external temperature. After a reaction time of 1 hour a further 30 g of AIBN were added. Dilution was carried out after 4 hours and after 8 hours, in each case with 10.0 kg of acetone/benzine 60/95 (1:1) mixture. To reduce the residual initiators, 90 g portions of Perkadox® 16 were added after 8 hours and again after 10 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=24 500 g/mol; M_{w}=871 000 g/mol. K value: 48.2.

Polyacrylate PSA4 (PA4):

A 100 L glass reactor conventional for radical polymerizations was charged with 3.2 kg of acrylic acid, 8.0 kg of BA, 28.8 kg of IDA and 26.7 kg of acetone/isopropanol (94:6). After nitrogen gas had been passed through the reactor for 45 minutes with stirring, the reactor was heated to 58° C. and 30 g of Vazo® 67 were added. The external heating bath was subsequently heated to 75° C. and the reaction was carried out constantly at this external temperature. After a reaction time of 1 hour a further 30 g of Vazo® 67 were added. Dilution was carried out after 4 hours and after 8 hours, in each case with 10.0 kg of acetone/isopropanol (94:6) mixture. To reduce the residual initiators, 90 g portions of Perkadox® 16 were added after 8 hours and again after 10 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=35 000 g/mol; M_{w}=1 020 000 g/mol. K value: 52.9.

### COMPARATIVE EXAMPLE

### Polyacrylate PSA5 (PA5, monomer EHA with Iso Index of 1 and Tg>−60° C.)

A 100 L glass reactor conventional for radical polymerizations was charged with 4.0 kg of acrylic acid, 12.0 kg of BA, 24.0 kg of EHA and 26.7 kg of acetone/benzine 60/95 (1:1). After nitrogen gas had been passed through the reactor for 45 minutes with stirring, the reactor was heated to 58° C. and 30 g of AIBN were added. The external heating bath was subsequently heated to 75° C. and the reaction was carried out constantly at this external temperature. After a reaction time of 1 hour a further 30 g of AIBN were added. Dilution was carried out after 4 hours and after 8 hours, in each case with 10.0 kg of acetone/benzine 60/95 (1:1) mixture. To reduce the residual initiators, 90 g portions of Perkadox® 16 were added after 8 hours and again after 10 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=26 800 g/mol; M_{w}=809 000 g/mol. K value: 46.3.

### COMPARATIVE EXAMPLE

### Polyacrylate PSA6 (PA6, Monomer PHA and IBOA (Cyclic Monomer))

A 100 L glass reactor conventional for radical polymerizations was charged with 2.4 kg of acrylic acid, 12.0 kg of isobornyl acrylate (IBOA), 25.6 kg of PHA and 26.7 kg of acetone/benzine 60/95 (1:1). After nitrogen gas had been passed through the reactor for 45 minutes with stirring, the reactor was heated to 58° C. and 30 g of AIBN were added. The external heating bath was subsequently heated to 75° C. and the reaction was carried out constantly at this external temperature. After a reaction time of 1 hour a further 30 g of AIBN were added. Dilution was carried out after 4 hours and after 8 hours, in each case with 10.0 kg of acetone/benzine 60/95 (1:1) mixture. To reduce the residual initiators, 90 g portions of bis(4-tert-butylcyclohexyl) peroxydicarbonate were added after 8 hours and again after 10 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=24 800 g/mol; M_{w}=980 000 g/mol. K value: 50.1.

### COMPARATIVE EXAMPLE

### Polyacrylate PSA7 (PA7, Monomer iC17A with Iso Index of 3.1 and Tg<−60° C.)

A 100 L glass reactor conventional for radical polymerizations was charged with 11.0 kg of acrylic acid, 27.0 kg of BA, 62.0 kg of heptadecanyl acrylate (iC17A) and 72.4 kg of acetone/isopropanol (94:6). After nitrogen gas had been passed through the reactor for 45 minutes with stirring, the reactor was heated to 58° C. and 50 g of Vazo® 67 were added. The external heating bath was subsequently heated to 75° C. and the reaction was carried out constantly at this external temperature. After a reaction time of 1 hour a further 50 g of Vazo® 67 were added. Dilution was carried out after 3 hours of 20 kg of acetone/isopropanol (94:6) and after 6 hours with 10.0 kg of acetone/isopropanol (94:6). To reduce the residual initiators, 0.15 kg portions of Perkadox® 16 were added after 5.5 hours and again after 7 hours. The reaction was discontinued after a time of 24 hours and the batch was cooled to room temperature. The polyacrylate was subsequently blended with the crosslinker Uvacure® 1500 and diluted to a solids content of 30% with acetone. Molar masses by GPC (Method A3): Mₙ=27 000 g/mol; M_{w}=990 000 g/mol. K value: 50.1.

The PSAs PA1-PA7 were mixed in accordance with Table 1, still in solution, with a styrene block copolymer and a hydrocarbon tackifier resin and the mixture was then coated onto a siliconized release film (50 μm polyester) or onto an etched PET film 23 μm thick, and the applied coatings were dried. The coatweight was 50 g/m² (coating speed 2.5 m/min, drying tunnel 15 m, temperatures zone 1: 40° C., zone 2: 70° C., zone 3: 95° C., zone 4: 105° C.).

For the measurement of the technical adhesive properties of the inventive blend PSA examples B1-B8 and also of the comparative examples VB9-VB14, the measurements were first carried out without the polyacrylate foam carrier. The results in Table 1 indicate that, in comparison with the non-inventive blend PSA formulations, examples B1-B8 exhibit better peel adhesion on apolar substrates such as PE and a greater thermal shear strength; otherwise, however, properties are comparable. The straight-acrylate example VB14 suffers severe detractions in peel adhesion on PE.

II Preparation of the Starting Polymers for the Polyacrylate Foam VT and for PSA Tape Examples MT1 to MT15

Base Polymer P

A reactor conventional for radical polymerizations was charged with 30 kg of EHA, 67 kg of BA, 3 kg of acrylic acid and 66 kg of acetone/isopropanol (96:4). After nitrogen gas had been passed through the reactor for 45 minutes, with stirring, the reactor was heated to 58° C. and 50 g of Vazo® 67 were added. Thereafter the external heating bath was heated to 75° C. and the reaction was carried out constantly at this external temperature. After 1 hour a further 50 g of Vazo® 67 were added and after 4 hours the batch was diluted with 20 kg of acetone/isopropanol mixture (96:4). After 5 hours and again after 7 hours, re-initiation took place with 150 g of Perkadox® 16 each time, followed by dilution with 23 kg of acetone/isopropanol mixture (96:4). After a reaction time of 22 hours, the polymerization was discontinued and the batch was cooled to room temperature. The polyacrylate has a K value of 75.1, a solids content of 50.2% and average molecular weights of Mₙ=91 900 g/mol and M_{w}=1 480 000 g/mol.

TABLE 1
Examples B1-B8 and comparative examples VB9-VB15 - Technical adhesive data, crosslinking with 0.2% Uvacure 1500

| | | | | Peel | Peel | | | | | Elast. |
|---|---|---|---|---|---|---|---|---|---|---|
| | | | | adhesion on | adhesion on | HP, 10N, | HP, 10N, | | MST max | component |
| Ex. | PA | SBC | Resin | steel [N/cm] | PE [N/cm] | 23° C. [min] | 70° C. [min] | | [μm] | [%] |
| B1 | PA1 | Kraton D1118 | Dercolyte A115 | 6.27 | 2.68 | >10 000 | 569 | (C) | 52 | 80 |
| | (60%) | (20%) | (20%) | | | | | | | |
| B2 | PA1 | Kraton D1101 | Dercolyte A115 | 5.97 | 2.8 | >10 000 | 1920 | (C) | 38 | 63 |
| | (60%) | (20%) | (20%) | | | | | | | |
| B3 | PA1 | Kraton D1118 | Dercolyte A115 | 6.56 | 2.54 | >10 000 | 1250 | (C) | 59 | 75 |
| | (62%) | (18%) | (20%) | | | | | | | |
| B4 | PA2 | Kraton D1118 | Piccotac 1095 | 7.25 | 2.23 | >10 000 | 1860 | (C) | 89 | 75 |
| | (52.5%) | (22.5%) | (25%) | | | | | | | |
| B5 | PA3 | Kraton D1101 | Piccotac 1095 | 7.12 | 2.18 | >10 000 | 2800 | (C) | 64 | 81 |
| | (80%) | (10%) | (10%) | | | | | | | |
| B6 | PA3 | Kraton D1101 | Piccotac 1095 | 5.82 | 2.36 | >10 000 | 4500 | (A) | 88 | 75 |
| | (70%) | (20%) | (10%) | | | | | | | |
| B7 | PA4 | Kraton D1101 | Dercolyte A115 | 7.23 | 3.22 | >10 000 | 540 | (C) | 120 | 55 |
| | (70%) | (10%) | (20%) | | | | | | | |
| B8 | PA4 | Kraton D1101 | Dercolyte A115 | 6.99 | 3.12 | >10 000 | 1820 | (C) | 56 | 74 |
| | (60%) | (20%) | (20%) | | | | | | | |
| VB9 | PA5 | Kraton D1118 | Dercolyte A115 | 6.85 | 0.91 | >10 000 | 400 | (C) | 66 | 66 |
| | (60%) | (20%) | (20%) | | | | | | | |
| VB10 | PA5 | Kraton D1101 | Dercolyte A115 | 4.78 | 0.98 | >10 000 | 20 | (C) | 51 | 65 |
| | (60%) | (20%) | (20%) | | | | | | | |
| VB11 | PA5 | Kraton D1118 | Dercolyte A115 | 6.97 | 0.85 | >10 000 | 560 | (C) | 58 | 79 |
| | (62%) | (18%) | (20%) | | | | | | | |
| VB12 | PA6 | Kraton D1118 | Dercolyte A115 | 6.56 | 0.99 | >10 000 | 1100 | (C) | 39 | 75 |
| | (60%) | (20%) | (20%) | | | | | | | |
| VB13 | PA7 | Kraton D1118 | Dercolyte A115 | 2.36 | 0.15 | 2500 (C) | <10 | (C) | 166 | 67 |
| | (60%) | (20%) | (20%) | | | | | | | |
| VB14 | PA2 | — | — | 5.80 | 1.00 | >10 000 | 2200 | (C) | 470 | 95 |

Peel adhesion steel and PE = Method H1,
HP = Holding power times 23° and 70° C. = Method H2 (C = Cohesive fracture, A = Adhesive fracture),
MST = Microshear test = Method H3,
Elast. component = Elastic component

Process 1: Concentration/Preparation of Hotmelt PSAs:

The base polymer P is very largely freed from the solvent by means of a single-screw extruder (concentrating extruder, Berstorff GmbH, Germany) (residual solvent content 0.3 wt %). The parameters for the concentration of the base polymer were as follows:

The screw speed was 150 rpm, the motor current 15 A, and a throughput of 58.0 kg liquid/h was realized. For concentration, a vacuum was applied at three different domes. The reduced pressures were, respectively, between 20 mbar and 300 mbar. The exit temperature of the concentrated hotmelt P was approximately 115° C. The solids content after this concentration step was 99.8%.

Process 2: Preparation of Inventive Adhesive Tapes, Blending with the Crosslinker-Accelerator System for Thermal Crosslinking, and Coating

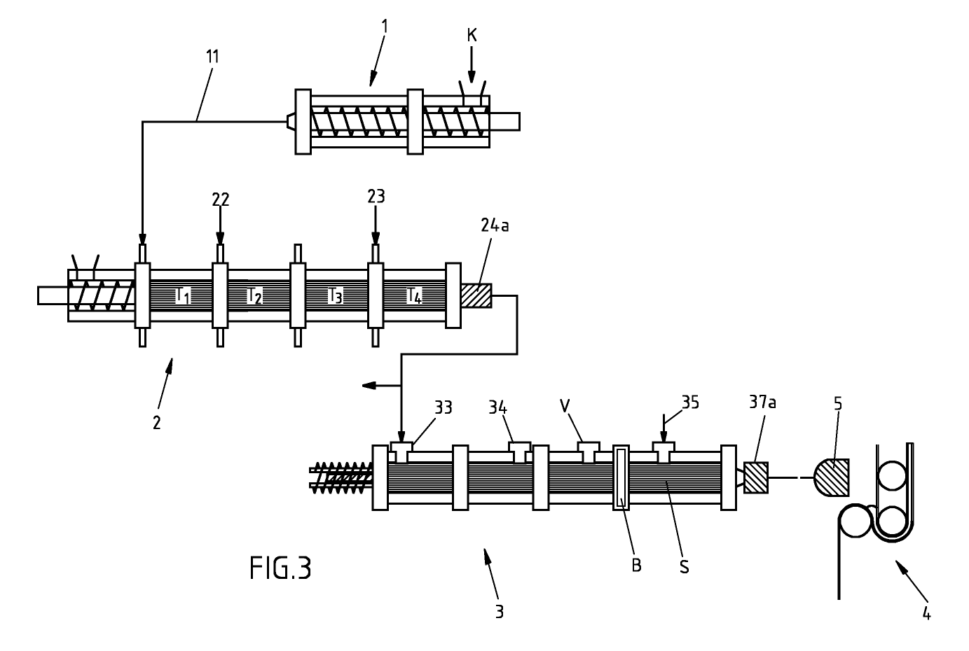

Foaming took place in an experimental unit which corresponds to the illustration in FIG. 3.

The base pump 24a and a heatable hose 24b, the polymer melt was transferred to a twin-screw extruder 3 (from BERSTORFF) (feed position 33). At position 34, the accelerator component was added. Subsequently the mixture as a whole was freed from all gas inclusions in a vacuum dome V at a pressure of 175 mbar (for the criterion for freedom from gas, see above). Downstream of the vacuum zone, on the screw, there was a blister B, which allowed a build-up of pressure in the subsequent segment S. Through appropriate control of the extruder speed and of the melt pump 37a, a pressure of greater than 8 bar was built up in the segment S between blister B and melt pump 37a, and at the metering point 35 the microballoon mixture (microballoons embedded into the dispersing assistant in accordance with the details given for the experimental series) was added, and was incorporated homogeneously into the premix by means of a mixing element. The resultant melt mixture was transferred into a die 5.

Following departure from the die 5, in other words after a drop in pressure, the incorporated microballoons underwent expansion, with the drop in pressure resulting in a low-shear cooling of the polymer composition. This produced a foamed carrier material. This carrier material was subsequently coated on both sides with the PSAs set out below, each of which was supplied on a release material which can be used again after being removed (in-process liner). The resulting three-layer assembly was shaped to a web by means of a roll calender 4.

In order to improve the anchoring of the PSAs from examples B1-B8 and also VB9-VB14 on the shaped polyacrylate foam VT, not only the PSAs but also the foam were pretreated by corona (corona unit from VITAPHONE, Denmark, 70 W min/m²). After the production of the three-layer assemblies MT1-MT14, the corona treatment produced improved chemical attachment to the polyacrylate foam carrier layer.

The belt speed on passage through the coating unit was 30 m/min.

Downstream of the roll nip, a release material was removed and the completed three-layer product was wound with the remaining, second release material.

TABLE 2
Polyacrylate foam VT

| Example | | | | VT |
|---|---|---|---|---|
| Components | Base polymer P | | [wt %] | 97.8 |
| | Expancel 051 DU 40 | | | 1.5 |
| | Polypox R16 | | | 0.139 |
| | IPDA | | | 0.144 |
| | Reofos RDP | | | 0.41 |
| Construction | Thickness | | [μm] | 902 |
| | Density | | [kg/m³] | 749 |
| Technical | HP | RT 20 N | [min] | 1874 |
| adhesive | | 70° C. 10 N | | 1282 |
| properties | Peel adhesion on | instantaneous | [N/cm] | 24.5 A |
| | steel | 3 d | | 33.4 A |
| | | 14 d | | 35.1 A |

Density: Method A4,
Peel adhesion: Method H2,
HP (Holding power): Method M2

Presented below are the results both for the inventive adhesive tapes, comprising the polyacrylate foam carrier VT with the inventive blend PSA examples B1-B8 with a double-sided coatweight of 50 g/m², and for the comparative examples, comprising the polyacrylate foam carrier VT with the noninventive PSA examples VB9-VB14, likewise with a double-sided coatweight of 50 g/m².

TABLE 3
Peel adhesions on steel and PE and also peel increase of
the three-layer PSA tapes MT1-MT14 comprising the polyacrylate
foam carrier VT with a total thickness of 1000 μm

| | | | | Peel | Peel | Peel | Peel |
|---|---|---|---|---|---|---|---|
| | | | | adhesion | adhesion | adhesion | adhesion |
| | | Peel adhesion on | | on steel, | on steel, | on steel, | on PE, |
| | | steel, instantaneous | | 8 h, | 1 d, | 3 d, | 3 d, |
| | | [N/cm] | | [N/cm] | [N/cm] | [N/cm] | [N/cm] |
| Ex. | PSA | open side | lined side | open side | open side | open side | open side |
| MT1 | B1 | 22.2 | 22.0 | 44 f.s. | 48 f.s. | 48 f.s. | 10.1 |
| MT2 | B2 | 30.5 | 30.7 | 46 f.s. | 51 f.s. | 50 f.s. | 10.3 |
| MT3 | B3 | 32.9 | 31.9 | 46 f.s. | 50 f.s. | 49 f.s. | 11.8 |
| MT4 | B4 | 25.7 | 25.7 | 44 f.s. | 48 f.s. | 48 f.s. | 12.1 |
| MT5 | B5 | 30.4 | 30.2 | 48 f.s. | 47 f.s. | 48 f.s. | 11.6 |
| MT6 | B6 | 32.5 | 32.6 | 47 f.s. | 50 f.s. | 51 f.s. | 11.2 |
| MT7 | B7 | 22.5 | 22.0 | 46 f.s. | 47 f.s. | 46 f.s. | 12.5 |
| MT8 | B8 | 31.9 | 31.9 | 48 f.s. | 49 f.s. | 49 f.s. | 12.6 |
| MT9 | VB9 | 21.8 | 21.7 | 35.6 | 44 f.s. | 48 f.s. | 9.8 |
| MT10 | VB10 | 29.7 | 29.5 | 34.7 | 48 f.s. | 48 f.s. | 7.5 |
| MT11 | V11 | 22.1 | 22.2 | 37.2 | 46 f.s. | 47 f.s. | 6.8 |
| MT12 | VB9 | 29.1 | 28.9 | 38.1 | 44 f.s. | 44.f.s. | 9.2 |
| MT13 | VB13 | 12.3 | 12.7 | 15.6 | 22.1 | 22.2 | 2.6 |
| MT14 | VB14 | 11.5 | 10.1 | 45 f.s. | 45 f.s. | 44 f.s. | 12.6 |

PSA = (Blend) pressure-sensitive adhesive formulation,
peel adhesion on steel = Method M1
(f.s. = foam split)

In comparison to the examples with the inventive blend PSA formulations MT1-MT8, comparative examples MT9-MT13 in Table 3 show lower peel adhesion on PE and also a slower peel increase for comparable instantaneous peel adhesion on steel. The use of a straight-acrylate PSA as an outer layer (MT14) results in significantly lower instantaneous bonding values, although the peel increase is comparable with that of the blends.

Table 4 sets out the holding power times and also the results for wetting and dewetting under load, as obtained by the rigid wet-out test. It is evident that apart from comparative example MT13, the cohesion is comparable in all cases. In example MT13, the polyacrylate PA7 with the multiply branched acrylate comonomer iC17 is used, resulting generally in poor results for shear strength. In all cases except one, with minimal dewetting, the inventive examples MT1-MT8 display further-advancing wetting after three days. In contrast, all blend PSA formulations using the non-inventive polyacrylates PA5-PA7 exhibit significant dewetting. This is also apparent in example MT14, in which a straight acrylate was used.

TABLE 4
Holding power times and rigid rigid wet-out testing of the three-layer
PSA tapes MT1-MT14 comprising the polyacrylate foam carrier VT
with a total thickness of 1000 μm

| | | | | | Dewetting |
|---|---|---|---|---|---|
| | | | Wetting | Wetting | 100 μm, 4 kg, |
| | HP, 10 N, | HP, 10 N, | 100 μm, | 100 μm, | difference 3 d- |
| | 23° C. | 70° C. | 4 kg, 1 d, | 4 kg, 3 d, | instantaneous |
| | [min] | [min] | [%] | [%] | [%] |
| Ex. | open side | open side | open side | open side | open side |
| MT1 | >10000 | 4500 (A) | 90 | 90 | 0 |
| MT2 | >10000 | 4200 (A) | 85 | 91 | 6 |
| MT3 | >10000 | 5500 (C) | 82 | 82 | 0 |
| MT4 | >10000 | 3900 (C) | 86 | 88 | 2 |
| MT5 | >10000 | 4110 (C) | 91 | 93 | 2 |
| MT6 | >10000 | 5300 (C) | 85 | 92 | 7 |
| MT7 | >10000 | 5090 (A) | 88 | 89 | 1 |
| MT9 | >10000 | 4750 (C) | 87 | 86 | −1 |
| MT6 | >10000 | 4900 (A) | 93 | 52 | −41 |
| MT7 | >10000 | 4200 (A) | 89 | 61 | −28 |
| MT8 | >10000 | 1450 (C) | 82 | 42 | −40 |
| MT9 | >10000 | 3500 (C) | 92 | 63 | −29 |
| MT10 | >10000 | 4010 (A) | 82 | 56 | −26 |
| MT11 | >10000 | 2800 (A) | 81 | 54 | −27 |
| MT12 | >10000 | 5000 (C) | 75 | 22 | −53 |
| MT13 | 4200 (K) | 200 (C) | 85 | 12 | −73 |
| MT14 | >10000 | >10000 | 82 | 72 | −15 |

HP (Holding power): Method M2 (A = Adhesive fracture, C = Cohesive fracture),
rigid wet-out test: Method M3

1. Pressure-sensitive adhesive comprising
a) at least 50 wt %, based on the total weight of the pressure-sensitive adhesive, of at least one polymer A whose monomer basis comprises the following monomers:
a1) at least one (meth)acrylic ester having a homopolymer glass transition temperature of not more than −60° C. and an alcohol component based on a branched, primary alcohol, having an iso index of 1;
a2) at least one (meth)acrylic ester having an alcohol component based on a linear C₁-C₁₈ alcohol;
a3) acrylic acid;
b) at least 5 wt %, based on the total weight of the pressure-sensitive adhesive, of at least one synthetic rubber; and
c) at least 10 wt %, based on the total weight of the pressure-sensitive adhesive, of at least one peel adhesion-reinforcing resin.

2. Pressure-sensitive adhesive according to claim 1, wherein the pressure-sensitive adhesive is thermally crosslinked by at least one epoxycyclohexyl derivative.

3. Pressure-sensitive adhesive according to claim 1, wherein the pressure-sensitive adhesive comprises at least one poly(meth)acrylate phase and at least one synthetic rubber phase.

4. Pressure-sensitive adhesive according to claim 3, wherein the synthetic rubber phase is in dispersion in the poly(meth)acrylate phase.

5. Pressure-sensitive adhesive according to claim 1, wherein the at least one peel adhesion-reinforcing resin is a hydrocarbon resin.

6. Pressure-sensitive adhesive according to claim 1, wherein the at least one peel adhesion-reinforcing resin is incompatible with each poly(meth)acrylate phase of the pressure-sensitive adhesive.

7. Adhesive tape comprising a foamed carrier and a pressure-sensitive adhesive according to claim 1.

8. Adhesive tape according to claim 7, wherein the foamed carrier comprises a syntactic polymer foam.

9. Adhesive tape according to claim 8, wherein the syntactic polymer foam comprises at least 50 wt %, based on the total weight of the foam, of one or more poly(meth)acrylates.

10. Adhesive tape according to claim 7, wherein the pressure-sensitive adhesive is laminated on at least one side of the foamed carrier.

11. Adhesive tape according to claim 7, wherein the foamed carrier comprises at least 50 wt %, based on the total weight of the foam, of at least one poly(meth)acrylate B which can be traced back to the following monomer composition:
b1) 65 to 97 wt % of ethylhexyl acrylate and/or butyl acrylate,
b2) 0 to 30 wt % of methyl acrylate,
b3) 3 to 15 wt % of acrylic acid.

12. Adhesive tape according to claim 7, wherein the foamed carrier is thermally crosslinked.

13. Adhesive tape according to claim 7, wherein the pressure-sensitive adhesive is applied to both sides of the foamed carrier.

14. A method of providing rapid wetting of surfaces having different surface energies, said method comprising adhering an adhesive tape according to claim 7 to said surfaces.
